(19) United States
(12) Patent Application Publication
(10) Pub. No.: US 2018/0154441 A1
(43) Pub. Date: Jun. 7, 2018

(54) METHODS AND TABLE SUPPORTS FOR ADDITIVE MANUFACTURING

(71) Applicant: GENERAL ELECTRIC COMPANY, Schenectady, NY (US)

(72) Inventors: Michael D. MILLER, Cincinnati, OH (US); Earl Neal DUNHAM, Cincinnati, OH (US); John WESTENDORF, Loveland, OH (US); John William MOORES, West Chester, OH (US)

(21) Appl. No.: 15/372,053

(22) Filed: Dec. 7, 2016

(51) Int. Cl. B22F 3/105; B29C 67/00; B28B 1/00; B28B 23/00; B33Y 10/00; B33Y 30/00; B23K 26/342; B23K 26/70

(52) U.S. Cl. CPC B22F 3/1055; B29C 67/0077; B29C 67/0092; B28B 1/001; B28B 23/0056; B22F 2998/10; B33Y 30/00; B23K 26/342; B23K 26/702; B22F 2003/1058; B33Y 10/00

(57) ABSTRACT

The present disclosure generally relates to methods for additive manufacturing (AM) that utilize table support structures in the process of building objects, as well as novel table support structures to be used within these AM processes. The table support structures include a first leg portion extending vertically from a build platform; a platform portion including a horizontal top surface supported on the first leg portion; and a plurality of supports extending from the platform portion to a downfacing surface of the object.

### INTRODUCTION

The present disclosure generally relates to methods for additive manufacturing (AM) that utilize support structures in the process of building objects, as well as novel support structures to be used within these AM processes.

### BACKGROUND

AM processes generally involve the buildup of one or more materials to make a net or near net shape (NNS) object, in contrast to subtractive manufacturing methods. Though “additive manufacturing” is an industry standard term (ASTM F2792), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. A particular type of AM process uses an energy beam, for example, an electron beam or electromagnetic radiation such as a laser beam, to sinter or melt a powder material, creating a solid three-dimensional object in which particles of the powder material are bonded together. Different material systems, for example, engineering plastics, thermoplastic elastomers, metals, and ceramics are in use. Laser sintering or melting is a notable AM process for rapid fabrication of functional prototypes and tools. Applications include direct manufacturing of complex workpieces, patterns for investment casting, metal molds for injection molding and die casting, and molds and cores for sand casting. Fabrication of prototype objects to enhance communication and testing of concepts during the design cycle are other common usages of AM processes.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758 describe conventional laser sintering techniques. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate and the effects of processing parameters on the microstructural evolution during the layer manufacturing process have not been well understood. This method of fabrication is accompanied by multiple modes of heat, mass and momentum transfer, and chemical reactions that make the process very complex.

FIG. 1 is schematic diagram showing a cross-sectional view of an exemplary conventional system 100 for direct metal laser sintering (DMLS) or direct metal laser melting (DMLM). The apparatus 100 builds objects, for example, the part 122, in a layer-by-layer manner by sintering or melting a powder material (not shown) using an energy beam 136 generated by a source such as a laser 120. The powder to be melted by the energy beam is supplied by reservoir 126 and spread evenly over a build plate 114 using a recoater arm 116 travelling in direction 134 to maintain the powder at a level 118 and remove excess powder material extending above the powder level 118 to waste container 128. The energy beam 136 sinters or melts a cross sectional layer of the object being built under control of the galvo scanner 132. The build plate 114 is lowered and another layer of powder is spread over the build plate and object being built, followed by successive melting/sintering of the powder by the laser 120. The process is repeated until the part 122 is completely built up from the melted/sintered powder material. The laser 120 may be controlled by a computer system including a processor and a memory. The computer system may determine a scan pattern for each layer and control laser 120 to irradiate the powder material according to the scan pattern. After fabrication of the part 122 is complete, various post-processing procedures may be applied to the part 122. Post processing procedures include removal of excess powder by, for example, blowing or vacuuming. Other post processing procedures include a stress relief process. Additionally, thermal, mechanical, and chemical post processing procedures can be used to finish the part 122.

The apparatus 100 is controlled by a computer executing a control program. For example, the apparatus 100 includes a processor (e.g., a microprocessor) executing firmware, an operating system, or other software that provides an interface between the apparatus 100 and an operator. The computer receives, as input, a three dimensional model of the object to be formed. For example, the three dimensional model is generated using a computer aided design (CAD) program. The computer analyzes the model and proposes a tool path for each object within the model. The operator may define or adjust various parameters of the scan pattern such as power, speed, and spacing, but generally does not program the tool path directly.

FIG. 2 illustrates a plan view of a conventional support structure 220 used to vertically support a portion of an object 210. The support structure 220 is a matrix support including cross hatching (e.g., scan lines) forming a series of perpendicular vertical walls. The area between the platform 114 and an overhanging portion of the object may be filled with such matrix support, which may provide a low density structure for supporting the overhanging portion as it is built. In an aspect, a matrix support may be automatically generated for an object to support any bottom surface of the object that is not connected to the platform 114. For example, the MAGICS™ software from Materialise NV may generate matrix supports for the object within a CAD model.

FIG. 3 illustrates another example object 300 and a conventional support structure 310. FIG. 3 illustrates a vertical cross section of the object 300 and the support structure 310. The object 300 is a cylindrical object having an external flange 302 at one end. The object 300 is oriented such that the axis of the cylindrical object is vertical and the flange 302 is located at a top end. If no support structure were included, the flange 302 would likely cause build errors because the relatively large bottom surface of the flange 302 would be unsupported. The support structure 310 is a matrix support for the flange 302. The matrix support 302 fills the entire volume between the flange 302 and the build plate 114.

The present inventors have discovered that conventional matrix supports may have various drawbacks. For example, matrix supports, especially for large volumes, may require a significant build time. For example, the support 310 fills a significant volume in comparison to the object 300 and uses a significant amount of time to scan each of the individual lines forming the matrix support. Additionally, the matrix supports may result in a significant quantity of unusable fused material that is scrapped.

In view of the above, it can be appreciated that there are problems, shortcomings or disadvantages associated with AM techniques, and that it would be desirable if improved methods of supporting objects and support structures were available.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

In one aspect, the disclosure provides a method of fabricating an object. The method includes: (a) irradiating a layer of powder in a powder bed with an energy beam in a series of scan lines to form a fused region; (b) providing a subsequent layer of powder over the powder bed by passing a recoater arm over the powder bed from a first side of the powder bed to a second side of the powder bed; and (c) repeating steps (a) and (b) until the object and at least one support structure is formed in the powder bed. The support structure includes a first leg portion extending vertically from a build platform. The support structure includes a platform portion including a horizontal top surface supported on the first leg portion. The support structure includes a plurality of supports extending from the platform portion to a downfacing surface of the object.

In another aspect, the disclosure provides a support structure for fabricating an object on a layer-by-layer basis. The support structure includes a first leg portion extending vertically from a build platform. The support structure includes a platform portion including a horizontal top surface supported on the first leg portion. The support structure includes a plurality of supports extending from the platform portion to a downfacing surface of the object.

These and other aspects of the invention will become more fully understood upon a review of the detailed description, which follows.

### BRIEF DESCRIPTION OF THE DRAWINGS

FIG. 1 is schematic diagram showing an example of a conventional apparatus for additive manufacturing.

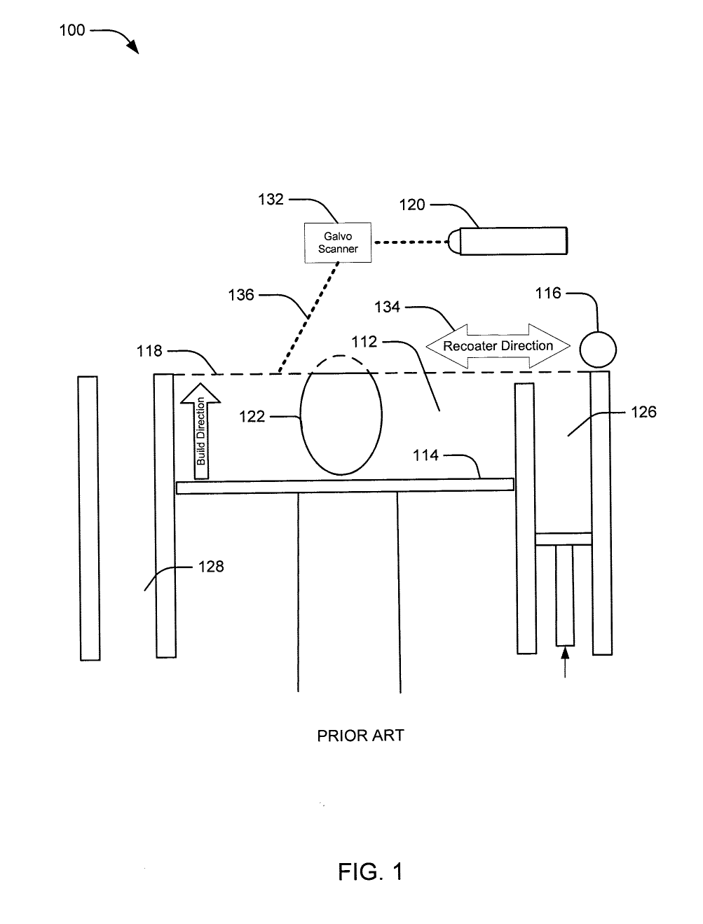

FIG. 2 illustrates a plan view of an example object and a conventional matrix support.

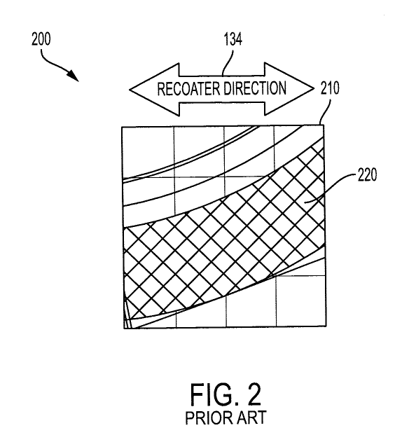

FIG. 3 illustrates a vertical cross-sectional view of another object supported by a conventional matrix support.

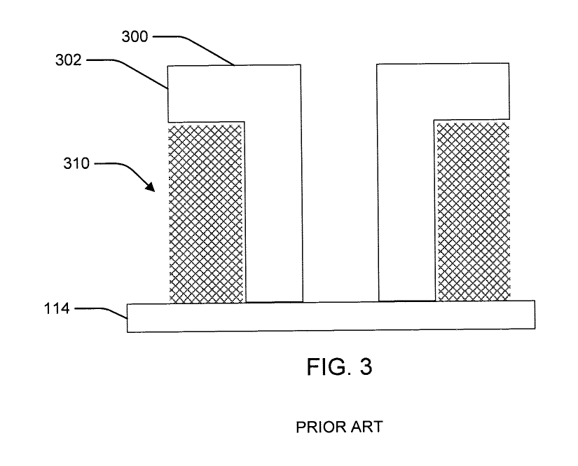

FIG. 4 illustrates a vertical cross-sectional view of an example object supported by a support structure according to an aspect of the disclosure.

FIG. 5 illustrates a vertical cross-sectional view of another example object supported by a support structure according to an aspect of the disclosure.

FIG. 6 illustrates a vertical cross-sectional view of another example object supported by a support structure according to an aspect of the disclosure.

FIG. 7 illustrates a vertical cross-sectional view of another example object supported by a support structure according to an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

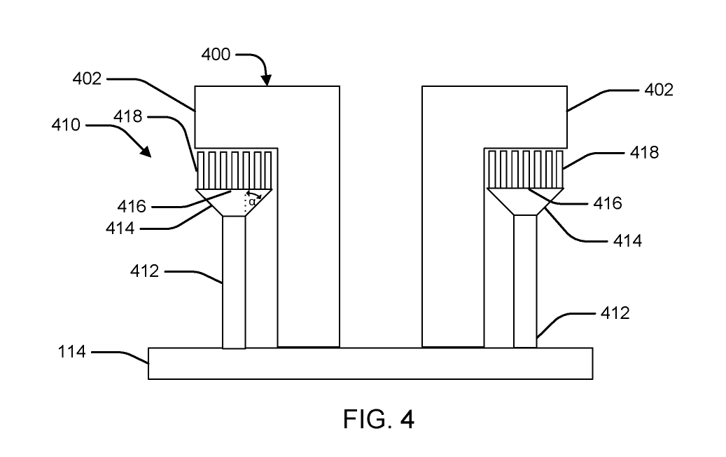

FIG. 4 illustrates a vertical cross-sectional view of an example object 400 supported by a support structure 410 according to an aspect of the disclosure. The object 400 is a cylindrical object having an external flange 402 at one end. The object 400 is oriented such that the axis of the cylindrical object 400 is vertical and the flange 402 is located at a top end. A bottom surface 404 of the flange 402 is a downward facing surface. Downward facing surfaces present difficulties in additive manufacturing processes such as DMLM and DMLS. For example, as the object 400 is built vertically and the build layer reaches the bottom layer of the flange 402, the bottom layer is built on top of unfused powder. The bottom surface 404 may be subject to warping due to heat differentials, pooling due to large areas of melted powder, or bending due to contact with the recoater 116. The build process may fail or produce a defective object 400 if the bottom surface 404 is not supported.

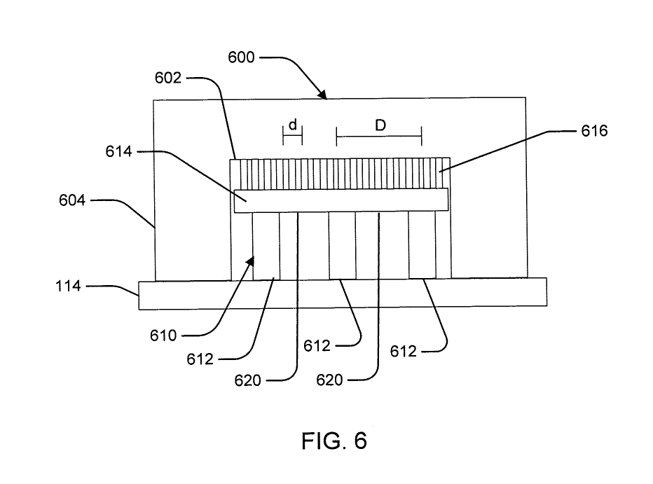

The support structure 410 supports the bottom surface 404. The support structure 410 includes a leg portion 412, an expansion portion 414, a horizontal surface 416, and a plurality of supports 418. In the illustrated example, the support structure 410 is generally cylindrical. It should be appreciated that similar support structures having similar cross-sections may be utilized to support differently shaped downward facing surfaces. The leg portion 412 is formed on the build plate 114 and extends vertically from the build plate 114. That is, the leg portion 412 may be formed by scanning the same location in the powder bed in each layer. In the illustrated example, the leg portion 412 has an annular shape and surrounds the object 400. In an aspect, as discussed in further detail below regarding FIG. 6, the leg portion 412 may include multiple leg portions. For example, multiple leg portions 412 may be built in a circle around the object 400. Additionally, the leg portion 412 may include additional features such as passages or powder removal ports, for example, to allow access to an area between the object 400 and the leg portion 412 before the object 400 and the support structure 410 are removed from the build plate 114.

The expansion portion 414 is built on top of the leg portion 412. The expansion portion 414 has an increasing width as the height increases. For example, the expansion portion 414 has a trapezoidal cross section. In an aspect, an angle from vertical (a) of a downward facing surface of the expansion portion 414 is determined based on constraints of the particular powder and the additive manufacturing apparatus 100. The support structure 410 may be a sacrificial structure and the surface quality of the expansion portion 414 may not be a critical factor. The angle α may be selected, however, to reduce probability of deformation of the expansion portion 414 by limiting the area of fused portion in each layer that is not directly supported by the layer immediately below. For example, an angle less than 60 degrees from vertical may provide an acceptably low probability of deformation. In an aspect, an angle of 45 degrees is preferable. When a smaller angle is selected, however, a taller expansion portion may be necessary to support the width of the bottom surface 504.

The horizontal surface 416 is a top surface of the expansion portion 414. The horizontal surface 416 is a portion of a layer where a continuous area is fused. The horizontal surface 416 provides a surface for building a plurality of supports 418. The horizontal surface 416 may be substantially horizontal. For example, the horizontal surface 416 may include indentations or projections. In an aspect, the horizontal surface 416 may have a maximum slope. For example, the maximum slope may be ±10 degrees.

The plurality of supports 418 extend from the horizontal surface 416 to the bottom surface 404. The plurality of supports 418 may be selected from known support types according to particular needs of the object 400. For example, the plurality of supports 418 may be breakaway supports that are easily removed from the object 400 during post-processing. In another aspect, the plurality of supports 418 may be rail supports that are aligned with a direction of the recoater 116. The plurality of supports 418 may have a minimum height. For example, the minimum height may be selected to allow breakage or machining of the plurality of supports. The plurality of supports 418 each have a width that is less than a width of the leg portion 412. For example, the width of the leg portion 412 may be at least three times the width of each of the plurality of supports 418. In an aspect, the heights of the different portions of the support structure 410 may be determined starting at the top. The plurality of supports 418 may be assigned the minimum height, the height of the expansion portion 414 may be determined based on the angle α, the width of the horizontal surface 416, and the width of the leg portion 412. The leg portion 412 may then be extruded from a bottom of the expansion portion to the build plate.

The support structure 410 is a monolithic structure. Although lines are shown between the various portions of the support structure 410 representing changes in the external surfaces, each portion is contiguous with the preceding portion. That is, as the support structure 410 is formed layer-by-layer, each newly added layer becomes fused to the layer directly underneath to form the support structure 410.

The present inventors have found that certain objects may benefit from a support structure 410 that includes a leg portion, expansion portion, and horizontal surface. In the example aspect illustrated in FIG. 4, the leg portion 412 spans a majority of the vertical distance between the build plate 114 and the bottom surface 404. The leg portion 412 has a smaller surface area in each layer than a conventional matrix support (e.g., matrix support 310) and may be built faster using less powder. In an aspect, unfused powder (e.g., powder between the leg portion 412 and the object 400) may be recycled for a subsequent build process.

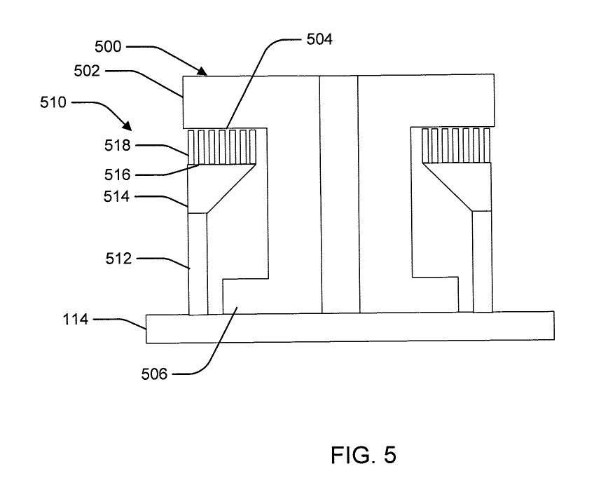

FIG. 5 illustrates a vertical cross-sectional view of another example object 500 supported by a support structure 510 according to an aspect of the disclosure. Similar to the object 400, the object 500 is a cylindrical object having an external flange 502 at a top end. A bottom surface 504 of the flange 502 is a downward facing surface. The object 500 also includes a flange 506 at a bottom end. The flange 506 extends directly below the flange 502. Accordingly, it may be difficult to locate the support structure 410 between the bottom surface 504 and the build plate 114. Further, it may be undesirable to build a support on top of the flange 506 (e.g., to prevent damaging a top surface of the flange 506 during removal of such a support).

The support structure 510 supports the bottom surface 504. The support structure 510 includes a leg portion 512, an expansion portion 514, a horizontal surface 516, and a plurality of supports 518. In the illustrated example, the support structure 510 is generally cylindrical. It should be appreciated that similar support structures having similar cross-sections may be utilized to support differently shaped downward facing surfaces. Like the support structure 410, the support structure 510 is a monolithic structure formed layer-by-layer from the build plate 114.

The leg portion 512 is formed on the build plate 114 and extends vertically from the build plate 114. That is, the leg portion 512 may be formed by scanning the same location in the powder bed in each layer. The leg portion 512 may be offset from a center of the bottom surface 504, for example, to avoid contact with the flange 506. An object may include other features that may be undesirable to contact with a support structure. For example, external surfaces where a particular surface quality is produced by the AM process may be undesirable to contact with a support structure as removal may include machining.

The expansion portion 514 is built on top of the leg portion 512. The width of the expansion portion 514 increases as the height increases. For example, the expansion portion 414 has a trapezoidal cross section. In the illustrated example, the expansion portion 514 expands in a radially inward direction while the radially external surface of the expansion portion is vertical. In an aspect, an angle from vertical (α) of a downward facing surface of the expansion portion 514 is determined based on constraints of the particular powder and the additive manufacturing apparatus 100. In this example, because the expansion portion 514 expands in only one direction, the height of the expansion portion 514 may be greater in order to reach a width approaching a width of the downward facing surface.

The horizontal surface 516 is a top surface of the expansion portion 514. The horizontal surface 516 is a portion of a layer where a continuous area is fused. The horizontal surface 516 provides a surface for building a plurality of supports 518. The plurality of supports 518 extend vertically from the horizontal surface 516 to the bottom surface 504. Similar to the plurality of supports 418, the plurality of supports 518 may be selected according to particular needs of the object 500.

FIG. 6 illustrates a vertical cross-sectional view of another example object 600 supported by a support structure 610 according to an aspect of the disclosure. The object 600 includes a downward facing surface 602. For example, the downward facing surface may be a ceiling of a cavity. It should be appreciated that similar principles are applicable to other downward facing surfaces (e.g., the bottom surfaces 404 and 504). Additionally, a downward facing surface need not be completely horizontal, for example, a downward facing surface may be any surface of an object that is not supported from directly below.

The support structure 610 includes a plurality of legs 612, a horizontal portion 614, and a plurality of supports 616. The support structure 610 is a monolithic structure built up from the build plate 114. Each of the plurality of legs 612 may initially be built separately, but the legs are joined when the horizontal portion 614 is built.

The plurality of legs 612 extend vertically from the build plate 114. That is, each of the plurality of legs 612 may be formed by scanning the same location in the powder bed in each layer. Each of the plurality of legs is spaced apart from the other legs by a portion of unfused powder. The distance between the legs may be determined based on constraints of the particular powder and the additive manufacturing apparatus 100. For example, a given powder and manufacturing apparatus may be associated with a maximum distance (D) for a horizontal span that can be manufactured with a minimal probability of deformation. For example, the maximum distance (D) may be between 0.25 inch and 1 inch. The number and locations of the plurality of legs 612 may be selected such that the distance between the plurality of legs 612 is less than the maximum distance.

The horizontal portion 614 is supported on the legs 612 and extends beneath the downward facing surface 602. The horizontal portion 614 itself includes downward facing surfaces 620 between the legs 612. The downward facing surfaces 620 may have different properties than the downward facing surface 602 because the downward facing surfaces 620 are part of a sacrificial support structure. For example, surface quality of the downward facing surfaces 620 may be unimportant. Also, because the horizontal portion 614 is supported by a plurality of legs, the width of any unsupported downward facing surface 620 is less than a width of the downward facing surface 602.

The plurality of supports 616 extend from the horizontal portion 614 to the downward facing surface 602 to support the downward facing surface 602. The plurality of supports 616 may be selected according to particular needs of the object 600. The downward facing surface 602 is a surface of the object 600. Accordingly, the downward facing surface 602 may have different manufacturing tolerances than the downward facing surfaces 620. For example, for the same given powder and manufacturing apparatus, a maximum distance (d) for a desired surface quality of the object 600 may be used to determine the distance between the number of supports 616. The maximum distance d for surfaces of the object 400 is less than the maximum distance D for a surface of the sacrificial support. Accordingly, the number of legs 612 is less than a number of supports 616. For example, the number of supports 616 may be at least three times the number of legs 612. Because the manufacturing tolerances for the downward facing surfaces 620 are less stringent than the manufacturing tolerances for the downward facing surfaces 602, fewer legs 612 may be used. The lower number of legs 612 results in a lower density of the fused region between the build plate 114 and the horizontal portion 614 than the density of the fused region between the horizontal portion 614 and the downward facing surface 602. In an aspect, the density of a fused region may be measured as a percentage of the volume above or below the horizontal portion 614 that has been fused. Accordingly, use of the legs 612 to support the horizontal portion 614 results in a savings of unfused powder and build time for the support structure that is approximately proportional to the difference in density times the percentage of the height occupied by the legs 612.

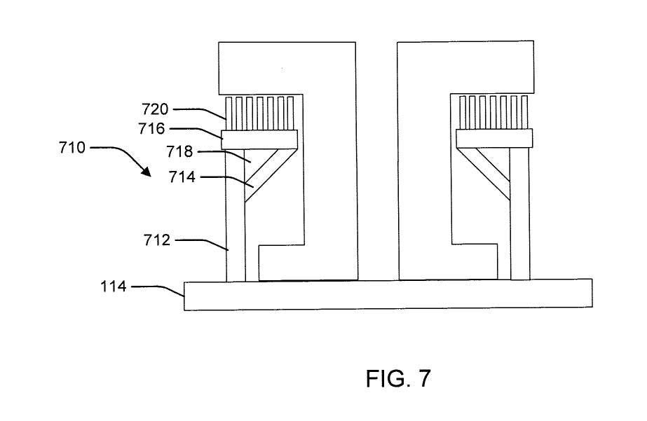

FIG. 7 illustrates a vertical cross-sectional view of the example object 500 supported by a support structure 710 according to an aspect of the disclosure. The object 500 is described above with respect to FIG. 5. The support structure 710 includes a leg portion 712, an angled strut 714, a horizontal portion 716, an open space 718, and a plurality of supports 720. The leg portion 712 extends vertically from the build plate 114. Instead of an expansion portion, the angled strut 714 extends diagonally upward from the leg portion 712 to the horizontal portion 716. The horizontal portion 716 extends between the leg portion 712 and the angled strut 714. A distance between a top of the leg portion 712 and a top of the angled strut 714 is less than the maximum distance for a horizontal span that can be manufactured with a minimal probability of deformation. The open space 718 is defined between the leg portion 712, the angled strut 714, and the horizontal portion 716. The open space 718 may contain unfused powder. The use of an angled strut may reduce the density of the fused region beneath the horizontal portion 716, thereby reducing build time and powder usage. The plurality of supports 720 may be built on top of the horizontal portion and may be similar to the plurality of supports 418, 518, 616.

Upon completion of the AM process, the support structures 410, 510, 610, 710 are removed from the respective object 400, 500, 600. In one aspect, the support structure 410, 510, 610, 710 is attached along with the object to the build plate 114 and may be detached from the build plate and discarded. In addition, the support structure 510, 610, 710 may be attached to the respective object 400, 500, 600 along each of the plurality of supports 418 which may be readily broken away once the AM process is complete. This may be accomplished by providing a breakaway structure—a small tab of metal joining the object 400 and support structure 410. The breakaway structure may also resemble a perforation with several portions of metal joining the object 400, 500, 600 and support structure 410, 510, 610, 710.

The removal of the support structure 410, 510, 610, 710 from the object 400, 500, 600 may take place immediately upon, or during, removal of the object from the powder bed. Alternatively, the support structure 410, 510, 610, 710 may be removed after any one of the post-treatment steps. For example, the object 400, 500, 600 and support structure 410, 510, 610, 710 may be subjected to a post-anneal treatment and/or chemical treatment and then subsequently removed from the object 400, 500, 600 and/or build plate. In an aspect, the leg portion 412, after removal from the build plate 114, may serve as a handle for removing the remaining portions of the support structure 410 from the object 400.

In an aspect, the apparatus 100 is used to form the objects 400, 500, 600 based on a three dimensional computer model of the object. Using a CAD program, the operator modifies the three dimensional model of the object to include one or more of support structures 410, 510, 610, 710. The operator may use software to generate one or more supports within the three dimensional model as solid objects. The CAD model is then provided to the apparatus 100, which builds the object and supports layer-by-layer.

In an aspect, multiple supports may be used in combination to support fabrication of an object, prevent movement of the object, and/or control thermal properties of the object. That is, fabricating an object using additive manufacturing may include use of one or more of: scaffolding, tie-down supports, break-away supports, lateral supports, conformal supports, connecting supports, surrounding supports, keyway supports, breakable supports, leading edge supports, ghost supports, rail supports, or powder removal ports. In particular, the plurality of supports discussed above may combine one or more of these support types. For example, scaffolding, break-away supports, conformal supports, and rail supports may be particularly useful as the plurality of supports. The following patent applications include disclosure of these supports and methods of their use:

U.S. patent application Ser. No. 15/042,019, titled “METHOD AND CONFORMAL SUPPORTS FOR ADDITIVE MANUFACTURING” with attorney docket number 037216.00008, and filed Feb. 11, 2016;

U.S. patent application Ser. No. 15/042,024, titled “METHOD AND CONNECTING SUPPORTS FOR ADDITIVE MANUFACTURING” with attorney docket number 037216.00009, and filed Feb. 11, 2016;

U.S. patent application Ser. No. 15/041,973, titled “METHODS AND SURROUNDING SUPPORTS FOR ADDITIVE MANUFACTURING” with attorney docket number 037216.00010, and filed Feb. 11, 2016;

U.S. patent application Ser. No. 15/042,010, titled “METHODS AND KEYWAY SUPPORTS FOR ADDITIVE MANUFACTURING” with attorney docket number 037216.00011, and filed Feb. 11, 2016;

U.S. patent application Ser. No. 15/042,001, titled “METHODS AND BREAKABLE SUPPORTS FOR ADDITIVE MANUFACTURING” with attorney docket number 037216.00012, and filed Feb. 11, 2016;

U.S. patent application Ser. No. 15/335,116, titled “METHODS AND THERMAL SUPPORTS FOR ADDITIVE MANUFACTURING” with attorney docket number 270368F/037216.00013, and filed Oct. 26, 2016;

U.S. patent application Ser. No. 15/041,991, titled “METHODS AND LEADING EDGE SUPPORTS FOR ADDITIVE MANUFACTURING” with attorney docket number 037216.00014, and filed Feb. 11, 2016;

U.S. patent application Ser. No. 15/041,980, titled “METHOD AND SUPPORTS WITH POWDER REMOVAL PORTS FOR ADDITIVE MANUFACTURING” with attorney docket number 037216.00015, and filed Feb. 11, 2016;

U.S. patent application Ser. No. 15/220,170, titled “METHODS AND GHOST SUPPORTS FOR ADDITIVE MANUFACTURING” with attorney docket number 2703681/037216.00016, and filed Jul. 26, 2016; and

U.S. patent application Ser. No. 15/153,445, titled “METHODS AND RAIL SUPPORTS FOR ADDITIVE MANUFACTURING” with attorney docket number 270368J/037216.00035, and filed May 12, 2016.

The disclosure of each of these applications are incorporated herein in their entirety to the extent they disclose additional support structures that can be used in conjunction with the support structures disclosed herein to make other objects.

Additionally, scaffolding includes supports that are built underneath an object to provide vertical support to the object. Scaffolding may be formed of interconnected supports, for example, in a honeycomb pattern. In an aspect, scaffolding may be solid or include solid portions. The scaffolding contacts the object at various locations providing load bearing support for the object to be constructed above the scaffolding. The contact between the support structure and the object also prevents lateral movement of the object.

Tie-down supports prevent a relatively thin flat object, or at least a first portion (e.g. first layer) of the object from moving during the build process. Relatively thin objects are prone to warping or peeling. For example, heat dissipation may cause a thin object to warp as it cools. As another example, the recoater may cause lateral forces to be applied to the object, which in some cases lifts an edge of the object. In an aspect, the tie-down supports are built beneath the object to tie the object down to an anchor surface. For example, tie-down supports may extend vertically from an anchor surface such as the platform to the object. The tie-down supports are built by melting the powder at a specific location in each layer beneath the object. The tie-down supports connect to both the platform and the object (e.g., at an edge of the object), preventing the object from warping or peeling. The tie-down supports may be removed from the object in a post-processing procedure.

A break-away support structure reduces the contact area between a support structure and the object. For example, a break-away support structure may include separate portions, each separated by a space. The spaces may reduce the total size of the break-away support structure and the amount of powder consumed in fabricating the break-away support structure. Further, one or more of the portions may have a reduced contact surface with the object. For example, a portion of the support structure may have a pointed contact surface that is easier to remove from the object during post-processing. For example, the portion with the pointed contact surface will break away from the object at the pointed contact surface. The pointed contact surface stills provides the functions of providing load bearing support and tying the object down to prevent warping or peeling.

Lateral support structures are used to support a vertical object. The object may have a relatively high height to width aspect ratio (e.g., greater than 1). That is, the height of the object is many times larger than its width. The lateral support structure is located to a side of the object. For example, the object and the lateral support structure are built in the same layers with the scan pattern in each layer including a portion of the object and a portion of the lateral support structure. The lateral support structure is separated from the object (e.g., by a portion of unmelted powder in each layer) or connected by a break-away support structure. Accordingly, the lateral support structure may be easily removed from the object during post-processing. In an aspect, the lateral support structure provides support against forces applied by the recoater when applying additional powder. Generally, the forces applied by the recoater are in the direction of movement of the recoater as it levels an additional layer of powder. Accordingly, the lateral support structure is built in the direction of movement of the recoater from the object. Moreover, the lateral support structure may be wider at the bottom than at the top. The wider bottom provides stability for the lateral support structure to resist any forces generated by the recoater.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

1. A method for fabricating an object, comprising:
(a) irradiating a layer of powder in a powder bed with an energy beam in a series of scan lines to form a fused region;
(b) providing a subsequent layer of powder over the powder bed; and
(c) repeating steps (a) and (b) until the object and at least one support structure is formed in the powder bed,
wherein the support structure comprises:
a first leg portion extending from a build platform;
a platform portion supported on the first leg portion; and
a plurality of supports extending from the platform portion toward a downfacing surface of the object.

2. The method of claim 1, wherein the platform portion extends from the first leg portion to a location above a portion of the object.

3. The method of claim 1, wherein a distance between the platform portion and the downfacing surface is at least at threshold distance.

4. The method of claim 1, wherein a number of leg portions including the first leg portion below the platform portion is less than a number of the plurality of supports.

5. The method of claim 4, wherein the number of the plurality of supports is at least three times the number of leg portions.

6. The method of claim 1, wherein the support structure includes a second leg portion extending from the build platform and spaced apart from the first leg portion.

7. The method of claim 6, wherein the platform extends substantially horizontally between the first leg and the second leg, wherein a spacing between the first leg and a second leg is less than a threshold distance.

8. The method of claim 6, wherein the threshold distance is three times a width of the first leg.

9. The method of claim 1, wherein the support structure further comprises an angled strut extending from the leg to the platform, wherein an angle between the vertical leg and a downfacing surface of the angled support is less than 45 degrees.

10. The method of claim 1, wherein a density of the fused region below the horizontal top surface is less than a density of the fused region above the horizontal top surface.

11. The method of claim 1, wherein the platform portion extends diagonally from the first leg portion at an angle less than 45 degrees from vertical to the horizontal top surface.

12. The method of claim 1, wherein a width of each of the plurality of supports is less than a width of the first leg.

13. A support structure for fabricating an object on a layer-by-layer basis, comprising:
a first leg portion extending from a build platform;
a platform portion supported on the first leg portion; and
a plurality of supports extending from the platform portion toward a downfacing surface of the object.

14. The support structure of claim 13, wherein the platform portion extends horizontally from the first leg portion to a location above a portion of the object.

15. The support structure of claim 13, wherein a distance between the platform portion and the downfacing surface is at least at threshold distance.

16. The support structure of claim 13, wherein a number of leg portions including the first leg portion below the platform portion is less than a number of the plurality of supports.

17. The support structure of claim 16, wherein the number of the plurality of supports is at least three times the number of leg portions.

18. The support structure of claim 13, wherein the support structure includes a second leg portion extending vertically from the build platform and spaced apart from the first leg portion.

19. The support structure of claim 18, wherein the platform portion extends horizontally between the first leg portion and the second leg portion, wherein a spacing between the first leg portion and a second leg portion is less than a threshold distance.

20. The support structure of claim 19, wherein the threshold distance is three times a width of the first leg portion.

21. The support structure of claim 13, wherein the support structure further comprises an angled strut extending from the first leg portion to the platform, wherein an angle from vertical of a downfacing surface of the angled strut is less than 45 degrees.

22. The support structure of claim 13, wherein a density of the support structure below the horizontal top surface is less than a density of the support structure above the horizontal top surface.

23. The support structure of claim 13, wherein the platform portion extends diagonally from the first leg portion at an angle less than 45 degrees from vertical to the horizontal top surface.

24. The support structure of claim 13, wherein a width of each of the plurality of supports is less than a width of the first leg.
